(19) United States
(12) Patent Application Publication
(10) Pub. No.: US 2023/0272940 A1
(43) Pub. Date: Aug. 31, 2023

(54) ADJUSTABLE PORT FOR RECOVERY VENTILATOR

(71) Applicant: Carrier Corporation, Palm Beach Gardens, FL (US)

(72) Inventors: Peter McKinney, Boulder, CO (US); Michael Silva, East Syracuse, NY (US); Kadidjatou Keita, Syracuse, NY (US)

(21) Appl. No.: 18/171,917

(22) Filed: Feb. 21, 2023

Related U.S. Application Data
(60) Provisional application No. 63/314,007, filed on Feb. 25, 2022.

(51) Int. Cl. F24F 13/02; F24F 13/20

(52) U.S. Cl. CPC F24F 13/0209; F24F 13/20; F24F 13/0272; F24F 12/001

(57) ABSTRACT

A ventilator includes a housing having at least one opening formed therein. The housing has a plurality of sides including a first side and a second side and a modular duct connector having a through hole for connection with a duct. The modular duct connector is connectable to the at least one opening of the housing in at least a first configuration and a second configuration. In the first configuration, the through hole is arranged at the first side of the housing and in the second configuration, the through hole is arranged at the second side of the housing.

### CROSS-REFERENCE TO RELATED APPLICATIONS

This application claims the benefit of U.S. Provisional Pat. Application No. 63/314,007, filed Feb. 25, 2022, the contents of which are incorporated by reference herein in their entirety.

### BACKGROUND

Embodiments of the present disclosure relate to the field of ventilators, and more particularly, to a modular housing for a ventilator such as a heat recovery ventilator or an energy recovery ventilator.

Building ventilation systems such as heat recovery ventilators (HRVs) and energy recovery ventilators (ERVs) are commonly sold as models that have differing inlet/outlet port directions but are otherwise identical. For instance, in one model all ports might be on the top of the housing to accommodate vertical ducting while another nearly identical model would feature ports on the sides of the housing for attachment to horizontal ducting.

### BRIEF DESCRIPTION

According to an embodiment, a ventilator includes a housing having at least one opening formed therein. The housing has a plurality of sides including a first side and a second side and a modular duct connector having a through hole for connection with a duct. The modular duct connector is connectable to the at least one opening of the housing in at least a first configuration and a second configuration. In the first configuration, the through hole is arranged at the first side of the housing and in the second configuration, the through hole is arranged at the second side of the housing.

In addition to one or more of the features described herein, or as an alternative, in further embodiments the modular duct connector further comprises a collar positioned coaxially with the through hole.

In addition to one or more of the features described herein, or as an alternative, in further embodiments the at least one opening is arranged at a corner of the housing.

In addition to one or more of the features described herein, or as an alternative, in further embodiments the at least one opening includes a first opening arranged at a first corner of the housing and a second opening arranged at a second corner of the housing.

In addition to one or more of the features described herein, or as an alternative, in further embodiments the modular duct connector includes a body having a first wall, a second wall, and a third wall, the first wall, the second wall, and the third wall being oriented perpendicular to one another and the through hole being formed in the first wall.

In addition to one or more of the features described herein, or as an alternative, in further embodiments the modular duct connector includes a fourth wall connected to the first wall, opposite the third wall, the fourth wall being oriented perpendicular to the first wall and the second wall, wherein the duct connector includes another through hole.

In addition to one or more of the features described herein, or as an alternative, in further embodiments the another through hole is formed in the first wall.

In addition to one or more of the features described herein, or as an alternative, in further embodiments the another through hole is formed in the one of the second wall, the third wall and the fourth wall.

In addition to one or more of the features described herein, or as an alternative, in further embodiments the modular duct connector includes a body having at least one wall, and a sealing groove is formed in a free edge of the at least one wall.

In addition to one or more of the features described herein, or as an alternative, in further embodiments comprising a plurality of fasteners for selectively connecting the modular duct connector to the housing in the first configuration and the second configuration.

In addition to one or more of the features described herein, or as an alternative, in further embodiments at least one of the plurality of fasteners is mounted to the modular duct connector.

In addition to one or more of the features described herein, or as an alternative, in further embodiments the at least one of the plurality of fasteners is mounted at an interior surface of the modular duct connector, at a location accessible via the through hole.

In addition to one or more of the features described herein, or as an alternative, in further embodiments the plurality of fasteners include a component body having at least one flange extending therefrom, the component body being rotatable about an axis between an unlocked first position in which the flange is engaged with a first stop and a second position in which the flange is engaged with a second stop.

In addition to one or more of the features described herein, or as an alternative, in further embodiments the modular duct connector further comprises a sealing cap and a collar connector separate from the sealing cap, the through hole being formed in the collar connector.

In addition to one or more of the features described herein, or as an alternative, in further embodiments the at least one opening includes a first opening and a second opening, the sealing cap being positionable within one of the first opening and the second openings and the collar connector being mounted to the other of the first opening and the second opening.

In addition to one or more of the features described herein, or as an alternative, in further embodiments the collar connector further comprises a body having an outer diameter generally equal to an inner diameter of the at least one opening such that a portion of the body is receivable within the at least one opening.

In addition to one or more of the features described herein, or as an alternative, in further embodiments the collar connector further comprises a flange extending radially outwardly from a central portion of the body, the flange being positionable in contact with a surface of the housing.

In addition to one or more of the features described herein, or as an alternative, in further embodiments comprising a handle for manipulating the sealing cap.

In addition to one or more of the features described herein, or as an alternative, in further embodiments the ventilator is one of an energy recover ventilator, a heat recovery ventilator, and a bypass ventilator.

### BRIEF DESCRIPTION OF THE DRAWINGS

The following descriptions should not be considered limiting in any way. With reference to the accompanying drawings, like elements are numbered alike:

FIG. 1 is a schematic diagram of an exemplary energy recovery ventilator according to an embodiment;

FIG. 2 is a perspective view of another energy recovery ventilator according to an embodiment;

FIG. 3 is a perspective view of an exemplary modular duct connector according to an embodiment;

FIGS. 4a-4d are perspective views of the modular duct connector shown in FIG. 3 in various configurations relative to the housing according to an embodiment;

FIG. 5 is a perspective view of an interior of an exemplary modular duct connector according to an embodiment;

FIG. 6 is a perspective view of an interior of a housing having a modular duct connector attached thereto according to an embodiment;

FIG. 7 is a perspective view of ventilator housing having another exemplary modular duct connector according to another embodiment;

FIG. 8 is a perspective view of ventilator housing having yet another exemplary modular duct connector according to another embodiment; and

FIG. 9 is a perspective view of ventilator housing having another exemplary modular duct connector according to another embodiment.

### DETAILED DESCRIPTION

A detailed description of one or more embodiments of the disclosed apparatus and method are presented herein by way of exemplification and not limitation with reference to the Figures.

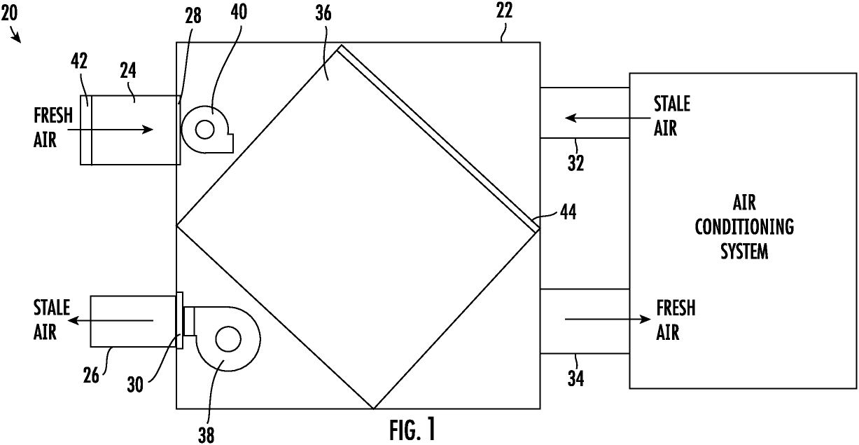

Referring now to FIG. 1, an exemplary ventilator 20, such as a heat recovery ventilator (HRV) and/or an energy recovery ventilator (ERV) for example, suitable for use with an air conditioning system is illustrated. When the ventilator 20 allows for the transfer of thermal energy without accompanying mass transfer (e.g., moisture, such as water for humidity control), the ventilator 20 may be viewed as an HRV. When the ventilator 20 allows for the transfer of water and thermal energy, the ventilator 20 may be viewed as an ERV. The ventilator 20 may recover the above-mentioned energy by intersecting (without mixing) the flow of stale conditioned air with the flow of fresh air using a recovery core 36. Although described herein that the ventilator 20 may exchange mass and/or thermal energy, it should be understood that in certain instances the ventilator 20 may be configured to bring in fresh air without the accompanying transfer of energy.

The ventilator 20 includes a generally rectangular housing 22 fitted with a fresh air intake duct 24 and an exhaust air duct 26. In an embodiment, both the fresh air intake duct 24 and the exhaust air duct 26 are coupled to a respective movable damper 28, 30. The dampers 28, 30 may selectively control or regulate the flow of fresh air entering the ventilator 20 via duct 24 and/or the flow of conditioned air exiting the ventilator 20 via duct 26. The dampers 28, 30 may have any suitable configuration, and in some embodiments are selectively controllable by a component of the air conditioning system. In an embodiment, the dampers 28, 30 are controllable by a furnace/fan coil controller (not shown), such as in response to signals indicative of temperature or humidity inside the ventilator 20 or inside the space being conditioned by the air conditioning system. In another embodiment, the dampers 28, 30 are controllable by circuitry within the ventilator itself or by an accompanying external control module. The ventilator 20 additionally includes an air return duct 32 for receiving conditioned air from the air conditioning system and a supply duct 34 for delivering the fresh air including the recovered energy to a downstream component of the air conditioning system.

The recovery core 36, when present, is arranged within the interior of the housing 22 so as to enable the exchange of energy between the fresh air and the stale conditioned air. The interior of the housing 22 is divided into four distinct quadrants, one associated with each of the fresh air inlet 24, the fresh air outlet 34, the conditioned air inlet 32, and the conditioned air outlet 26.

A fan 38 may be coupled to the recovery core 36 in order to induce air movement through the recovery core 36 and/or to induce to a positive air pressure in a portion of the air conditioning system. Alternatively, or in addition, a fan or blower 40 may be fluidly coupled to the fresh air intake duct 24 to induce air intake from an outdoor air space and/or to control the air flow rate entering the ventilator 20 from the outdoor air space.

A filter element 42 may be configured to filter the fresh air provided to the ventilator. Although the filter element 42 is illustrated as being mounted to a portion of the intake or inlet duct 24, embodiments where the filter element is mounted to the recovery core 36 or to a portion of the exhaust or outlet duct 34 are also within the scope of the disclosure. Alternatively, or in addition, the ventilator 20 may include a filter element 44 configured to filter the exhaust air stream that is received from the return air duct 32.

In operation, a fresh air stream, such as from an outdoor air space for example, enters the ventilator 20 through duct 24 while stale conditioned air from an interior conditioned air space provided to the ventilator 20 via the return air duct 32. The recovery core 36 extracts energy, such as in the form of heat and/or moisture for example, from the stale conditioned air and exhausts the stale conditioned air from the ventilator 20 as an exhaust air stream via exhaust duct 26. The fresh air circulates through the recovery core 36 such that the energy extracted from the stale conditioned air is transferred thereto prior to entering the air conditioning system via the supply duct 34. The ventilator 20 illustrated in FIG. 1 is intended as an example only, and it should be understood that a ventilator having another configuration is contemplated herein.

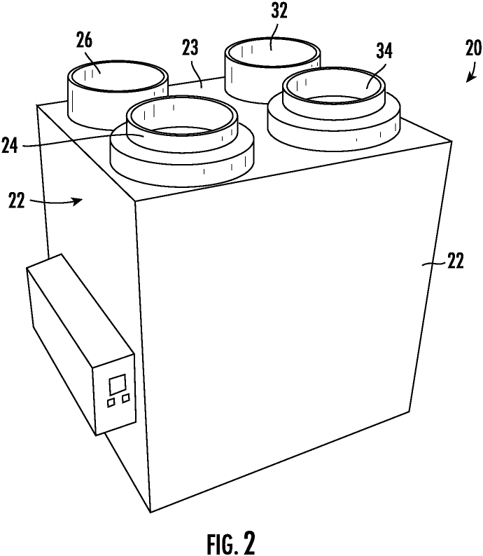

In the non-limiting embodiment of FIG. 1, the inlet and outlet ducts 24, 26, 32, 34 associated with both the first, fresh air flow and the second, stale or conditioned air flow are arranged at opposite lateral sides of the housing 22. However, the configuration of the ventilator 20, and more specifically the position of the inlet and outlet ducts 24, 26, 32, 34 relative to the housing 22, may vary based on the orientation of the ventilator 20 relative to the air conditioning system. For example, as shown in FIG. 2, in an embodiment, each of the plurality of inlet and outlet ducts 24, 26, 32, 34 may be mounted at the same side of the housing 22, such as at a top 23 of the housing 22. Embodiments where at least one first duct is mounted at a first side of the housing 22 (including a top or bottom thereof) and at least one second duct is mounted at a second side of the housing 22, directly adjacent to the first side of the housing are also within the scope of the disclosure. Although the position of the inlet and outlet ducts 24, 26, 32, 34 may vary, the arrangement of components within the interior of the housing 22 may, but need not, remain generally the same.

With reference now to FIGS. 2-8, an exemplary portion of a modular housing of a ventilator, such as a ventilator 20 is illustrated. As will be described in more detail below, because the inlet and outlet ducts may be easily installed about the housing of the modular ventilator at any suitable position, the need for a plurality of different housings with different inlet and outlet duct configurations is reduced or eliminated.

In the illustrated non-limiting embodiment, the housing 22 includes at least one a modular duct connector 50 configured to define an inlet or outlet of the housing 22 associated with one of the inlet ducts 24, 32, and outlet ducts 26, 34. The modular duct connector 50 includes a body having at least one wall and at least one through hole 52 formed therein. A collar 54 may be positioned coaxially with the through hole 52 and extend generally perpendicularly from a surface of the body. In an embodiment, an inner diameter of the collar 54 is equal to an outer diameter of the through hole 52 such that the interior of the collar 54 and the through hole 52 cooperate to form a continuous flow path into the housing 22. However, embodiments where the interior diameter of the collar 54 is slightly larger (or slightly smaller) than the outer diameter of the through hole 52 are also contemplated herein. Although both the through hole 52 and the collar 54 are illustrated as being circular in shape, embodiments where one or both of the through hole 52 and the collar 54 have an oval or slot configuration area also within the scope of the disclosure.

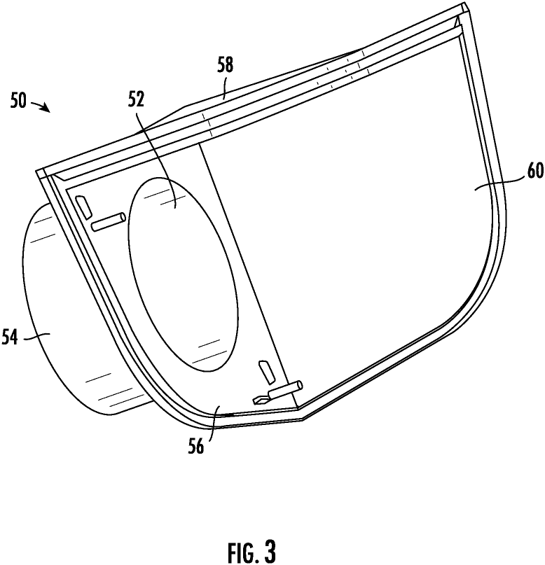

With reference to the embodiment illustrated in FIGS. 3-6, the modular duct connector 50 is configured to form a corner of the housing 22. Accordingly, the body of the modular duct connector 50 includes a first wall 56 having the through hole 52 and collar 54, a second wall 58, and a third wall 60. The second wall 58 extends generally perpendicularly from a first side of the first wall 56 in a direction opposite the collar 54, and the third wall 60 extends generally perpendicularly from a second side of the first wall 56, in the direction opposite the collar 54. The third wall 60 is also connected to and is oriented generally perpendicularly to the second wall 58. The distal or free edge of each of the first wall 56, second wall 58, and third wall 60 may have a substantially similar contour to allow the connector 50 to attach to a respective opening 62 in the housing 22 in a plurality of configurations. Accordingly, in such embodiments, each of the plurality of sides of the housing 22 defining an opening 62 formed at the corner thereof has a substantially similar shape, and a shape generally complementary to the contour of the free edges of the modular duct connector 50. In an embodiment, the shape of the opening 62 is selected to allow the connector 50 to easily slide onto the corner of the housing 22. Accordingly, an angle of the opening 62 may not be precisely parallel to a sliding direction to prevent binding of the connector 50 relative to the housing 22.

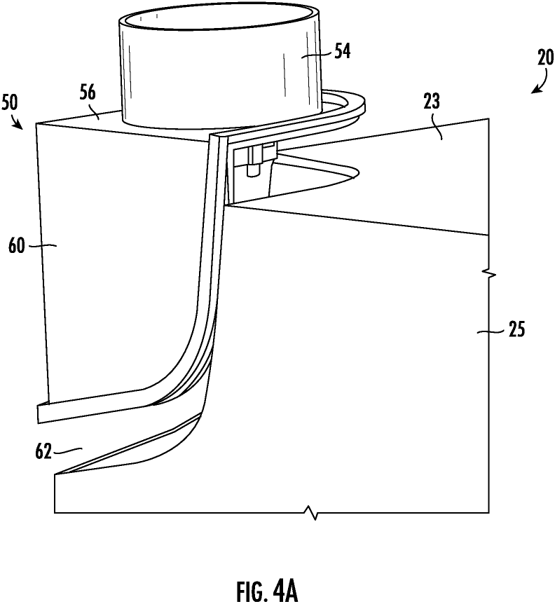

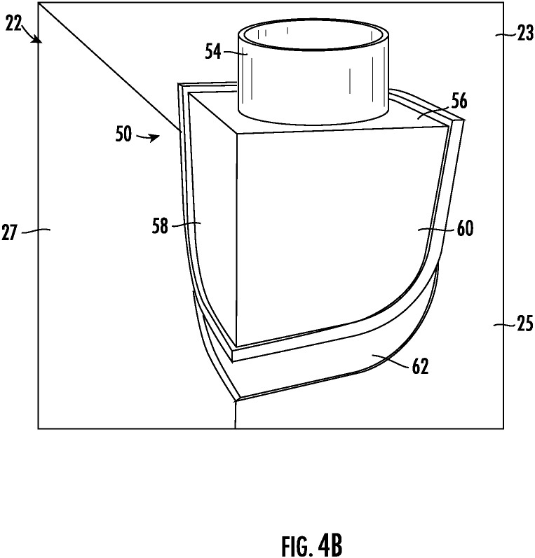

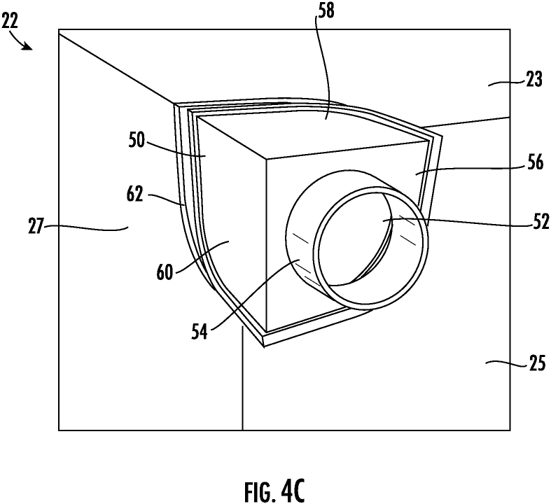

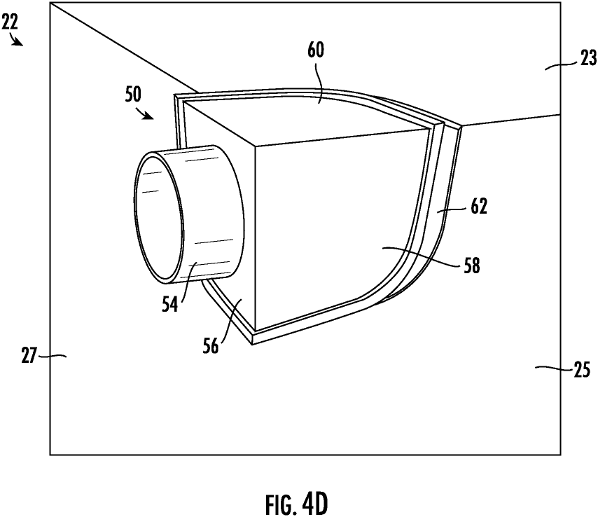

As shown in FIGS. 4a-4d, the modular duct connector 50 may be connectable to the housing 22 in either a first configuration, a second configuration, or a third configuration. In the first configuration, shown in FIGS. 4a and 4b, the first wall 56 of the modular duct connector 50 including the collar 54 is aligned with a top 23 of the housing 22, and the second and third walls 58, 60 are arranged at a front 25 and side 27 of the housing 22, respectively. In the second configuration (see FIG. 4c), the first wall 56 is aligned with the front 25 of the housing 22 and the second and third walls 58, 60 are arranged at the side 27 and top 23 of the housing 22, respectively. In the third configuration, as shown in FIG. 4d, the first wall 56 and the collar 54 are aligned with the side 27 of the housing 22 and the second and third walls 58, 60 are positioned adjacent to the top 23 and front 25 of the housing 22, respectively.

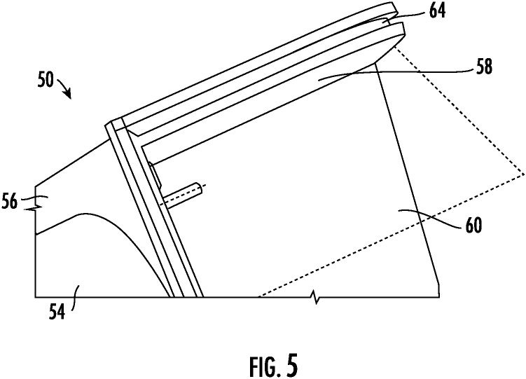

With reference now to FIG. 5, in an embodiment, a sealing groove 64 is formed along at least a portion of the free edge of one of the walls 56, 58, 60 of the modular duct connector 50, such as the second wall 58 for example. Alternatively, or in addition, a sealing material or gasket is arranged at the edges of the housing 22 adjacent the opening 62 and/or within the sealing groove 64. When the modular duct connector 50 is installed relative to the housing 22, the sealing groove 64 may engage or receive a corresponding sealing surface (not shown) formed in the housing 22. Accordingly, through this interaction, a seal is formed at the interface between the wall 58 and the housing 22. In an embodiment, only one wall, such as the second wall 58 includes this sealing groove 64. As a result, the interface between the other walls of the duct connector 50, such as the first wall 56 and the third wall 60 for example, and the housing 22 may not form an air-tight seal. However, embodiments where such a seal is formed at more than one or at each of the plurality of walls of the modular duct connector 50 such that the duct connector 50 is substantially sealed about its entire interface with the housing 22 are also contemplated herein.

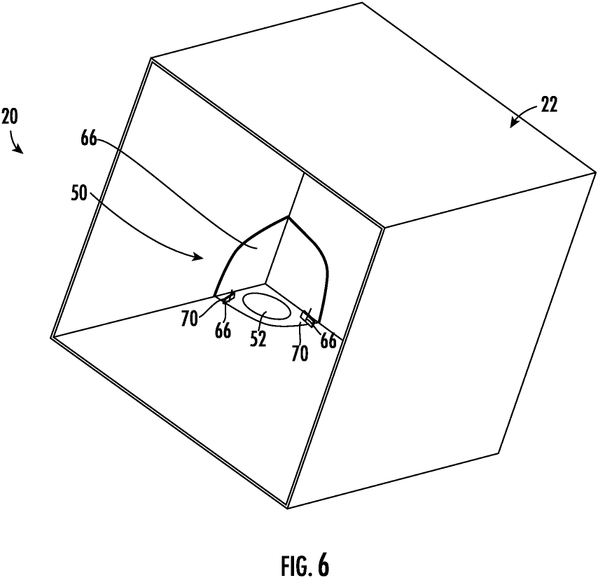

In an embodiment, the modular duct connector 50 includes one or more fasteners 66 to mechanically couple the modular duct connector 50 to the housing 22. In the illustrated, non-limiting embodiment, the modular duct connector 50 includes a plurality of fasteners 66 mounted at an interior surface 68 thereof. When mounted at the interior surface 68 of the duct connector 50, the fasteners 66 may be arranged at a location accessible via the through hole 52 formed in the first wall 56. As shown in FIG. 6, the fastener 66 may be a cap, toggle or other component rotatable about an axis, such as about 90 degrees for example, such that a flange extending from the body of the component 66 is configured to overlap an adjacent surface of the housing 22. The modular duct connector 50 may include one or more stops 70 positioned in the path of rotation of the flange to define an unlocked or connected position and a locked or connected position, respectively. It should be understood that the fasteners 66 illustrated and described herein are intended as an example only and that any suitable fastener operable to couple the duct connector 50 to the housing 22 is within the scope of the disclosure. Further, although the fasteners 66 are illustrated as being mounted to the modular duct connector 50, embodiments where one or more fasteners 66 are mounted to the housing 22 are also contemplated herein.

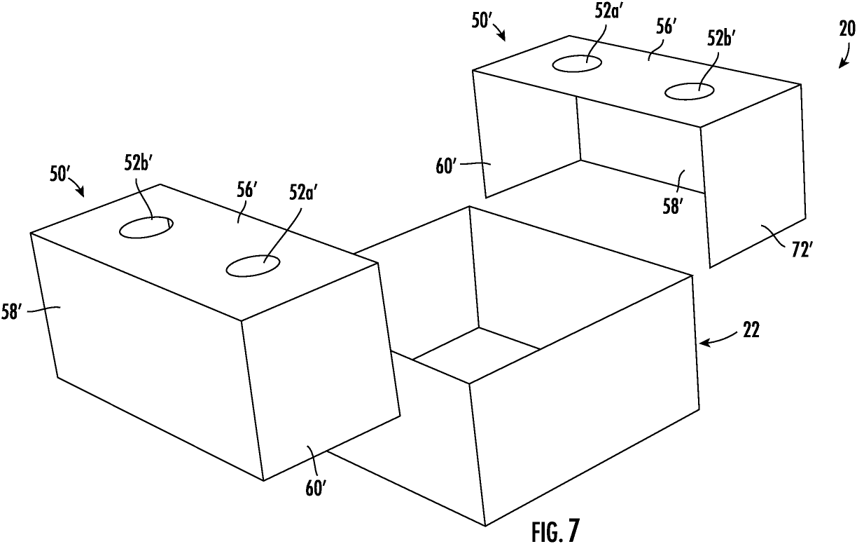

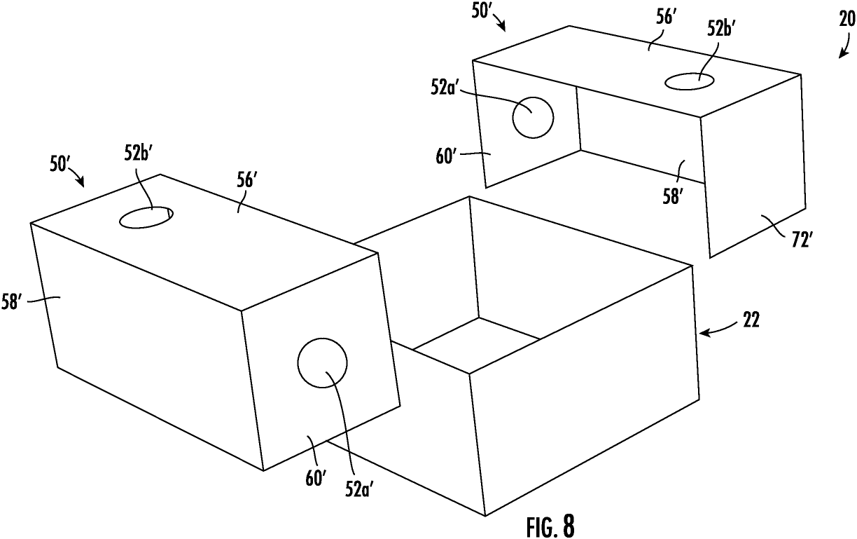

With reference now to FIGS. 7-8, an exemplary modular duct connector 50′ according to another embodiment is illustrated. The modular duct connector 50′ FIG. 7 is configured to form both a first corner and a second corner of the housing 22. In the illustrated, non-limiting embodiment, the body of the modular duct connector 50′ includes a plurality of through holes, such as two through holes 52a′ 52b′ for example. Although the first and second through holes 52a′ 52b′ are illustrated as being formed in the same wall of the duct connector 50′ in FIG. 7, embodiments where the plurality of through holes are formed at different walls, as shown in FIG. 8, are also contemplated herein. Similar to the modular duct connector previously disclosed, the modular duct connector 50′ of FIG. 7 includes a first wall 56′, a second wall 58′, and a third wall 60′ that cooperate to define a corner. However, the modular duct connector 50′ additionally includes a fourth wall 72′ coupled to a side of the first wall 56′ and the second wall 58′, opposite the third wall 60′. Accordingly, the first wall 56′, second wall 58′, and fourth wall 72′ cooperate to define a second corner. In the same manner as previously disclosed, the duct connector 50′ may be flipped or rotated relative to the housing 22 to achieve a plurality of different configurations. As previously described, one or more surfaces of the connector 50′ and/or one or more surfaces of the housing 22 configured to couple to the connector 50′ may include a sealing material and/or a complementary groove to form a sealed interface between the connector 50′ and the housing 22.

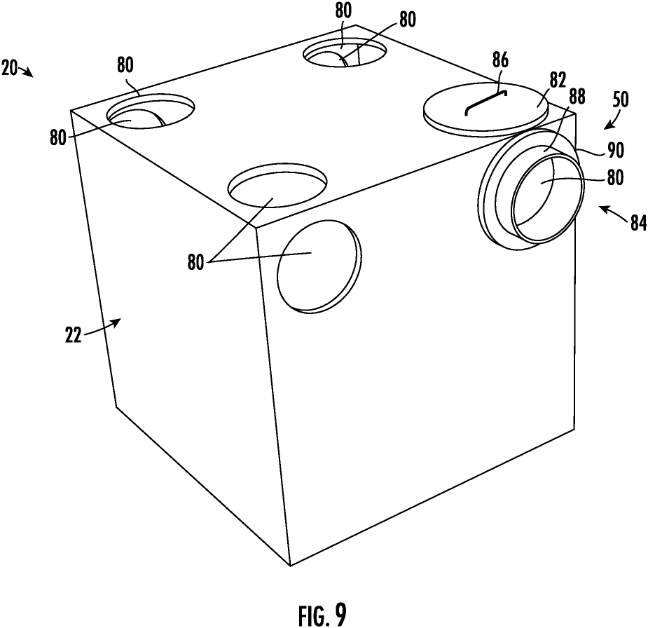

With reference now to FIG. 9, in another embodiment, the housing 22 may have a plurality of holes or openings 80 formed at each potential location of a inlet duct or outlet duct 24, 26, 32, 34. In the illustrated, non-limiting embodiment, the modular duct connector 50 includes a sealing cap 82 and a separate collar connector 84 connectable to the housing 22 individually. The sealing cap 82 may be connected to the housing 22, such as inserted or press fit or threaded into a first opening of the plurality of openings 80 to seal and block a flow through the opening 80. In an embodiment, the sealing cap 82 has a handle 86 mounted at an exterior thereof to provide an easy grasping point. In an embodiment, the handle 86 is a molded feature integral with the sealing cap. However, any suitable configuration that allows for grasping of the sealing cap 82 is within the scope of the disclosure. For example, embodiments including one or more finger grooves (not shown) formed in the surface of the housing 22 adjacent the opening 80 or depressions and/or protrusions built into the sealing cap 82 are also contemplated herein.

The collar connector 84 is includes a body 88 having an outer diameter generally equal to an inner diameter of one of the openings 80 such that a portion of the body 88 may be inserted into a second opening of the plurality of openings 80. In an embodiment, the collar connector 84 includes a flange 90 extending radially outwardly from a central portion of the body 88. When the collar connector 84 is installed, the flange 90 is configured to abut against either an interior surface or an exterior surface of the housing 22 to properly position the collar connector 84. Because the flange 90 is arranged at a central portion of the body 88, the body 88 will extend beyond the flange 90 in both directions, thereby forming a collar at an exterior of the housing 22 to which an inlet duct or an outlet duct 24, 26, 32, 34 may be connected.

A modular duct connector 50 as described herein allows the location of the inlet and outlet ducts 24, 26, 32, 34 relative to the housing to be adjusted without altering the configuration of the housing. As a result, the total number of products required for distribution would be reduced. In addition, installers would have choices for installation with a single product.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A ventilator comprising:
a housing having at least one opening formed therein, the housing having a plurality of sides including a first side and a second side; and
a modular duct connector having a through hole for connection with a duct, the modular duct connector being connectable to the at least one opening of the housing in at least a first configuration and a second configuration, wherein in the first configuration, the through hole is arranged at the first side of the housing and in the second configuration, the through hole is arranged at the second side of the housing.

2. The ventilator of claim 1, wherein the modular duct connector further comprises a collar positioned coaxially with the through hole.

3. The ventilator of claim 1, wherein the at least one opening is arranged at a corner of the housing.

4. The ventilator of claim 3, wherein the at least one opening includes a first opening arranged at a first corner of the housing and a second opening arranged at a second corner of the housing.

5. The ventilator of claim 3, wherein the modular duct connector includes a body having a first wall, a second wall, and a third wall, the first wall, the second wall, and the third wall being oriented perpendicular to one another and the through hole being formed in the first wall.

6. The ventilator of claim 5, wherein the modular duct connector includes a fourth wall connected to the first wall, opposite the third wall, the fourth wall being oriented perpendicular to the first wall and the second wall, wherein the duct connector includes another through hole.

7. The ventilator of claim 6, wherein the another through hole is formed in the first wall.

8. The ventilator of claim 6, wherein the another through hole is formed in the one of the second wall, the third wall and the fourth wall.

9. The ventilator of claim 1, wherein the modular duct connector includes a body having at least one wall, and a sealing groove is formed in a free edge of the at least one wall.

10. The ventilator of claim 1, further comprises a plurality of fasteners for selectively connecting the modular duct connector to the housing in the first configuration and the second configuration.

11. The ventilator of claim 10, wherein at least one of the plurality of fasteners is mounted to the modular duct connector.

12. The ventilator of claim 11, wherein the at least one of the plurality of fasteners is mounted at an interior surface of the modular duct connector, at a location accessible via the through hole.

13. The ventilator of claim 10, wherein the plurality of fasteners include a component body having at least one flange extending therefrom, the component body being rotatable about an axis between an unlocked first position in which the flange is engaged with a first stop and a second position in which the flange is engaged with a second stop.

14. The ventilator of claim 1, wherein the modular duct connector further comprises:
a sealing cap; and
a collar connector separate from the sealing cap, the through hole being formed in the collar connector.

15. The ventilator of claim 14, wherein the at least one opening includes a first opening and a second opening, the sealing cap being positionable within one of the first opening and the second openings and the collar connector being mounted to the other of the first opening and the second opening.

16. The ventilator of claim 14, wherein the collar connector further comprises a body having an outer diameter generally equal to an inner diameter of the at least one opening such that a portion of the body is receivable within the at least one opening.

17. The ventilator of claim 16, wherein the collar connector further comprises a flange extending radially outwardly from a central portion of the body, the flange being positionable in contact with a surface of the housing.

18. The ventilator of claim 14, further comprising a handle for manipulating the sealing cap.

19. The ventilator of claim 1, wherein the ventilator is one of an energy recover ventilator, a heat recovery ventilator, and a bypass ventilator.
